(19) United States
(12) Patent Application Publication
(10) Pub. No.: US 2004/0165776 A1
(43) Pub. Date: Aug. 26, 2004

(54) Means of matching 2D motion vector fields in a render, match, and refine iterative 3D scene model refinement system so as to attain directed hierarchical convergence and insensitivity to color, lighting, and textures

(76) Inventor: Albert-Jan Brouwer, Delft (NL)

Correspondence Address: Albert-Jan Brouwer, St.-Eustatiusstraat 2, Delft, 2612 HA, NL

(21) Appl. No.: 10/659,280

(22) Filed: Apr. 16, 2004

Related U.S. Application Data
(60) Provisional application No. 60/412,005, filed on Sep. 20, 2002.

(51) Int. Cl. G06K 9/00; G06T 15/00

(52) U.S. Cl. 382/181; 382/154; 345/419

(57) ABSTRACT

This application concerns an enhancement of the render, match, and refine (RMR) method [0002] for 3D scene model refinement. A method is provided that allows for the directed refinement of camera and geometry associated parameters of the 3D scene model in a manner that is independent of lighting, color, and texture. The method is based on the matching of a rendered motion vector field to a motion vector field estimated from a recorded video stream.

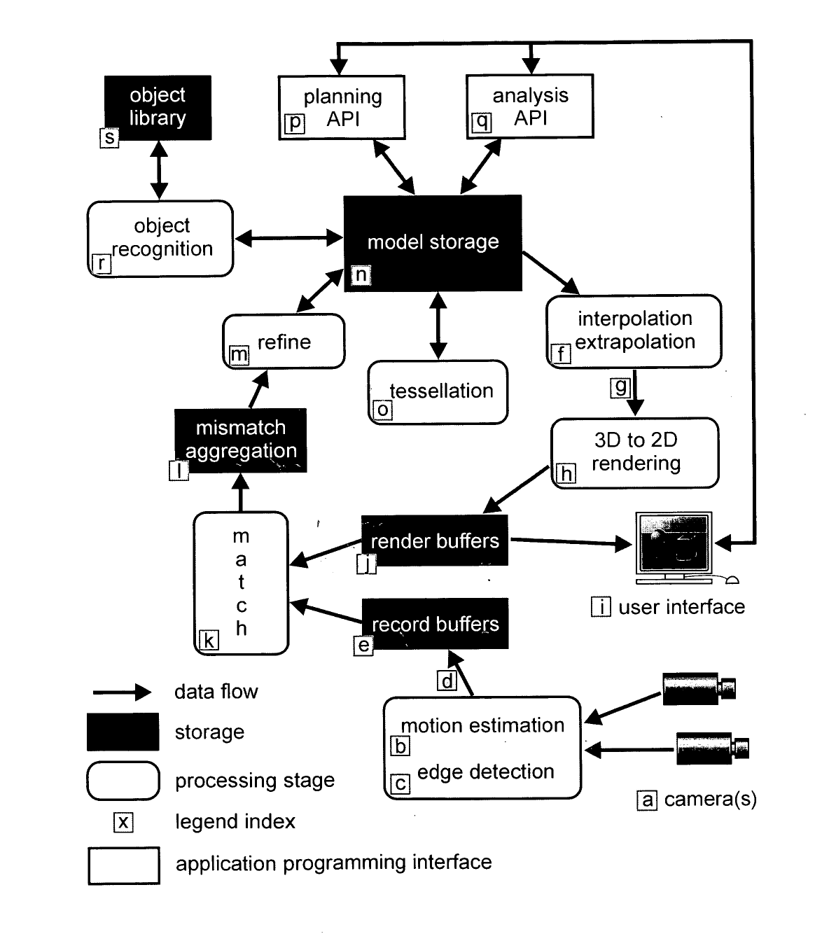

### BACKGROUND OF THE INVENTION

Automated 3D scene model refinement based on camera recordings has at least three application domains: computer vision, video compression, and 3D scene reconstruction.

The render, match, and refine (RMR) method for 3D scene model refinement involves rendering a 3D model to a 2D frame buffer, or a series of 2D frames, and comparing these to images or video streams recorded using one or more cameras. The mismatch between the rendered and recorded frames is subsequently used to direct the refinement of the scene model. The intended result is that on iterative application of this procedure, the 3D scene model elements (viewpoint, vertices, NURBS, lighting, textures, etc.) will converge on an optimal description of the recorded actual scene. The field of analogous model-based methods of which the RMR method is part is known as CAD-based vision.

Many implementations of 3D to 2D rendering pipelines exist. These perform the various steps involved in calculating 2D frames from a 3D scene model. When motion is modeled, model parameters that encode positions and orientations are made time dependent. Rendering a frame starts with interpolating the model at the frame time, resulting in a snapshot of positions and orientations making up the (virtual) camera view and geometry. In most rendering schemes, the geometry is represented by meshes of polygons as defined by the positions of their vertices, or translated into such a representation from mathematical or algorithmic surface descriptions (tessellation). Subsequently, the vertex coordinates are transformed from object coordinates to the world coordinate system and lighting calculations are applied. Then, the vertices are transformed to the view coordinate system, which allows for culling of invisible geometry and the clipping of the polygons to the view frustum. The polygons, usually subdivided in triangles, are then projected onto the 2D view plane. The projected triangles are rasterized to a set of pixel positions in a rectangular grid. At each of these pixel positions the z value, a measure for the distance of the surface to the camera, is compared to any previous values stored in a z buffer. When smaller, that part of the surface was in front of anything previously rendered to the same pixel position, and the corresponding z value is overwritten. The co-located pixel in the render buffer holding the color values is then also updated. The color is derived from an interpolation of the light intensities, colors, and texture coordinates of the three vertices making up the triangle.

In recent years, increasingly capable and complete hardware implementations of the rendering steps outlined under [0003] have emerged. Consequently, 3D to 2D rendering performance has improved in leaps and bounds. A compelling feature of the RMR method [0002] is that it can leverage the brute computational force offered by these hardware implementations and benefit from the availability of large amounts of memory. The main problem with the RMR method is the large number of parameters required for a 3D scene model to match an observed scene of typical complexity. These model parameters constitute a high-dimensional search space, which makes finding the particular set of parameters constituting the best match with the observed scene a costly affair involving many render, match, and refine iterations. The present invention reduces this cost.

The present invention makes use of the methods of a related invention [b]. It prescribes an enhancement of the RMR method based on the rendering of model element identifiers. This allows the 3D model elements involved in the rendering to particular 2D pixel positions to be identified so that they can be selectively refined. It also allows the matching and refinement to be partitioned.

Motion estimation algorithms can extract the apparent motion in the 2D pixel coordinate frame from the differences between subsequent frames in a video stream. Several methods for motion estimation have been developed. The main use of these algorithms is in the preprocessing stages of video compression algorithms. For the present invention, it suffices to note that such an algorithm can be applied to a stream of recorded camera frames to yield, for each frame, or between successive frames, a motion vector field describing the apparent motion at each pixel position.

The parameters of the 3D scene model can be classified into a hierarchy that is headed by the (virtual) camera parameters (orientation, position, zoom, etc.) followed by the geometry parameters (positions of vertices, coefficients of higher order surfaces, etc.) with the remaining parameter classes (surface colors, lighting, textures) at the bottom of the hierarchy. The camera and geometry parameters determine what 2D pixel coordinates the model elements are rendered to, whereas the remaining parameters affect only the coloring of those pixels. The present invention is designed to enable the RMR [0002] refinement of only the camera and geometry parameters of the 3D scene model while ignoring the remaining parameters

In order to render, match, and refine only camera and geometry parameters, 2D features that depend on these and no other parameters must be rendered from the 3D scene model. Furthermore, it must be possible to extract corresponding features from the camera frames recorded from the actual scene so that matching is possible.

Obvious features (in the projective 2D view plane) are boundaries, the areas within boundaries, and the corner points at the intersection of boundaries. Relative to the scene model, such boundaries include the visible outline or sharp edges of the geometry that can be expected to stand out if present in the actual scene and recorded with a camera. These can be easily rendered. Edge detection algorithms can be used to attempt the extraction of corresponding boundaries from the recorded scene frames.

If, in addition to or instead of a camera, a distance sensor is used (see for example [c]), the recorded z values can be matched to the rendered z buffer values at corresponding pixel positions.

### SUMMARY OF THE INVENTION

The present invention introduces a method that uses apparent motion as a further representation independent feature of the geometry and camera parameters for use in matching. It is based on an enhancement to 3D to 2D rendering [0003] that allows motion vector fields to be rendered. To do so, the model is interpolated at times close to the frame time. After transforming the corresponding geometry elements, whose positions in the 3D view coordinate system will differ slightly if camera or object motion is ongoing, the differences in the projected 2D view plane coordinates yield displacement vectors for the 2D motion (apparent motion) between these slightly different points in time. Through interpolation of these vectors during rasterization, a 2D motion vector field is rendered at all pixel positions. This prediction for the apparent motion can then be matched to the motion vector field obtained from the actual scene through a motion estimation [0006] algorithm.

A global matching of the rendered and recorded motion vector field provides information allowing refinement of camera parameters if these are not known or imprecisely known. This is because changes to the camera parameters affect the whole 2D frame whereas a particular geometry object present in the scene model is usually projected onto part of the frame, if at all.

Localized mismatches of the motion vectors and other match features ([0009] and optionally [0010]) reflect errors in geometry parameters. By using the model element identifier rendering method of a related invention [0005], the 2D frame is partitioned into subsets associated with different elements of the model geometry. The matching can then be performed separately for each such local subset. By tagging the match results with the model element identifier(s) associated with the local subset, the refinement algorithm is able to adjust the particular model elements involved in a mismatch.

By representing the mismatch information as 2D displacements (e.g. of boundaries) and differences between motion vectors, the refinement stage is provided with the information needed to make directed adjustments to the scene model parameters of the model element involved.

Iterative application of these rendering, matching, and refinement steps yields a converged set of camera and geometry parameters. Given these, a reverse mapping of the recorded pixel colors into texture map or surface coloring parameters of the model can be performed.

### DETAILED DESCRIPTION OF THE INVENTION

The diagram shown in drawing 1 represents a broader system as part of which the invention is of use. It aims to provide an example of the operational context for the invention. The diagram does not assume a specific implementation for the processing, data flow, and data storage it depicts. The current state of the art suggests hardware implementations for the 3D to 2D rendering, matching, motion estimation, and edge detection, with the remainder of the processing done in software.

a) One or more cameras record a stream of frames.

b) Motion estimation is used to pre-process the recorded camera streams into vector fields of motion between successive frames.

c) Edge detection marks boundaries in recorded camera frames detected from discontinuities in color or the motion vector field. The areas surrounded by these boundaries and intersection points of these boundaries can also be marked.

d) The raw frame data and corresponding extracted data (motion vectors, etc.) are stored in a record buffer.

e) Record buffers make the frame datasets available to the match stage. Memory limitations dictate that not every frame dataset can be retained. The frame pruning should favor the retention of frames corresponding to diverse viewpoints (stereoscopic, or historical) so as to prevent the RMR problem from being underdetermined (surfaces that remain hidden cannot be refined).

f) Interpolation or extrapolation of the model returns a snapshot of the time dependent 3D scene model at a particular past time, or extrapolated to a nearby future time.

g) Transfer of the model snapshots provides input for the 3D to 2D rendering stage. In addition to conventional input, identifiers of the model elements to which the various bits of geometry correspond are also passed along for joint rendering.

h) 3D to 2D rendering operates as outlined under [0003]. In addition to the conventional types of rendering, the pipeline is set up to also render identifiers [0005] and, using the methods detailed for the present invention, motion vectors.

i) In case of supervised or semi-autonomous applications, the rendered model can be displayed via a user interface to allow inspection of or interaction with the scene model.

j) Render buffers receive the various types data rendered for a model snapshot: color values, z values, identifiers, motion vectors, texture coordinates and so on.

k) The match stage compares the render buffers to the record buffers. Mismatch information is parceled up with model identifiers and transferred to an aggregation buffer. To prevent overtaxing the refinement stage, the degree of mismatch can be compared to a threshold below which mismatches are ignored.

l) The mismatch parcels are sorted into lists per model element via the included identifiers. The mismatches are aggregated until the match stage completes. This ensures that all mismatches pertaining to the same model element are available before refinement proceeds.

m) Refinement makes adjustments to the model based on the mismatches, the current model state, and any domain knowledge such as an object library. The adjusted model is tested during the next render and match cycle. Efficient execution of this task is a complex undertaking requiring software such as an expert system.

n) The model storage contains data structures representing the elements of the 3D scene model.

o) Tessellation produces polygon meshes suitable for rendering from mathematical or algorithmic geometry representations. Such representations require fewer parameters to approximate a surface, and thereby reduce the dimensionality of the refinement search space.

p) The RMR method aims to automatically produce a refined 3D scene model of the actual environment. The availability of such a model enables applications. For different application types, APIs can be created that help extract the required information from the scene model. Autonomous robotics applications can benefit from a planning API that assists in “what if” evaluation for navigation or modeling of the outcome of interactions with the environment.

q) Computer vision applications can benefit from an analysis API that helps yield information regarding distances, positions, volumes, collisions, and so on.

r) One means of exploiting domain knowledge to assist refinement is to use newly refined geometry to locate candidate objects in a library, which can then be inserted as a hypothesis into the model. Many methods of object recognition exist. A particularly suitable method involves the extraction of an orientation independent distribution from the geometry, which can then be used as a simple signature that allows a fast search of the library [d].

s) Optional library holding objects likely to be encountered in the environment.

The summarized rendering of motion vectors [0011] can be detailed for standard rendering pipelines [0003] that process surface geometry as polygons. The vertices defining the polygons project to particular 2D view coordinates for a temporal interpolation (snapshot) of the time dependent scene model. By doing this projection for model snapshots taken at two slightly different times and taking the difference of each resulting pair of 2D view coordinates, the apparent motion vector of each vertex between these two times can be calculated. Subsequently, the motion vector is scaled to match the normalization of the motion vectors produced by the motion estimation algorithm. Both vector components are then associated with the vertex for rendering in the same way that color components, alpha values, and texture coordinates are.

On rasterization, the motion components of the vertices in a polygon must be interpolated just like texture coordinates or, in case of Gouraud shading, color components. For details on the requisite calculations refer for example to the section on polygon rasterization in the OpenGL specification (downloadable from www.opengl.org). For precision, the interpolation should be perspective correct, particularly when the tessellation is coarse. The interpolated motion components are stored in a separate render buffer if z-comparison shows that the respective bit of the polygon is visible. The result is a rendered motion vector field.

The rendering and corresponding feature (boundaries, areas, points) extraction and classification is performed for a series of model snapshots that match the times and viewpoints of each of the frame data sets retained in the record buffers. Subsequently, mismatches can be determined. Information specifying the time and identifying the viewpoint is bundled with other mismatch information so that the refinement stage knows what time and camera the mismatches it receives apply to.

The reader should appreciate that there are many ways in which the refinement stage of the RMR method can adjust the model given the mismatch information produced by the matching stage. By summing the mismatches into a single cost function, even a standard optimization algorithm that is ignorant of the model could do the job given sufficient iterations and viewpoints. In practice, the refinement will need to make use of domain knowledge in order to attain acceptable performance for non-trivial scenes. This is an open-ended affair: it will always be possible to improve refinement with further rules, domain data, and so on. Thus, the precise design of the refinement stage is outside the scope of the present application. The given examples of the use of mismatch data for refinement serve only to illustrate the utility of the information produced by the matching methods of the present invention to refinement in general. Since the optimal choice of representation of the mismatch data is in part dependent on the implementation of the refinement stage, the present application limits itself to the describing what information is to be bundled into the mismatches without prescribing its representation.

Global (frame wide and high) matching of the rendered and recorded motion vector fields is done by calculating the difference vectors between corresponding vectors in either field. This can be done for all pixels positions, but for the intended purpose it will likely suffice to do so for a subset of the pixels distributed across the frame (e.g. every Nth pixel along both the x and y direction). This set of difference vectors constitutes the global motion mismatch that is passed on to the refinement stage.

As an example of how global motion mismatches can be used for refinement, consider a scene of distant stationary objects. Distinct patterns of apparent motion are produced when rotating the camera around each of the axes of a reference frame affixed to the camera. The same holds for zooming the camera objective. If all objects in the scene are “at infinity”, any apparent motion must be a superposition of these “eigen fields” so that on decomposition the instantaneous angular velocities and zoom rate of the camera can be established. Often, a large fraction of the 2D view area is taken up by background objects. In such cases, similar eigen decomposition of the global motion mismatch can yield approximate corrections for the camera parameters in the model.

Additional information can be bundled with the difference vectors in a global mismatch. In particular, the bundling of z values allows the refinement stage to separate the mismatch of apparent motion of foreground and background objects provided that the model is close to convergence.

Given the various render buffers (color, z, motion, identifiers, texture coordinates) and the richness of the 3D model, there is a wealth of options for determining 2D boundaries, areas, and points through analyzing the render buffers or through rendering to additional buffers. For example, occlusion edges can be determined from discontinuity boundaries in either the z-buffer or the motion vector buffer, or by locating the edges that join polygons facing towards and away from the virtual camera (and thus lie on object outlines). For the present application it suffices to note that it is possible to obtain and classify distinctive features (boundaries, areas, points) on rendering to match any features that can be extracted from the poorer (2D instead of 3D, subject to noise and blurring, limited depth of field) recorded information.

The availability of both the recorded frames and their estimated motion vector fields allows for a more detailed classification of extracted features. If a discontinuity boundary detected in the frame buffer (colors) coincides with a discontinuity in the motion vector field in a direction perpendicular to the boundary, the boundary separates a foreground object that is occluding a background object. If instead the motion vector field is continuous but nonzero, the boundary is likely due to a sharp edge or a transition of surface coloring that is part of the same object. In this way, different types of variation in the color and motion across the feature can help classify the feature. In addition to a discrete classification, a probability weighting can be performed on feature extraction. For example, discontinuities with a large contrast or appearing in both the frame and motion vector field can be assigned a relatively large weight. On matching, co-located features of compatible type and classification are compared.

Local matching is performed for each of the subsets of the 2D view plane as partitioned using the method [0005]. The following items are to be bundled into the mismatch parcel:

The model element identifiers rendered to each subset.

The difference vectors of the rendered and recorded motion vectors across the extent of the subset.

Classification, weights, positions, and/or displacements between co-located features extracted on rendering and recording in as far as these lie within or close to the extent of the subset.

The local mismatches are aggregated into lists per identifier before being passed on to the refinement stage so that all mismatch information pertaining to a particular model element is available when refinement commences.

The purpose of constructing mismatches according to [0026] is that identifiers allow the refinement stage to locate the model elements involved in the mismatch while the difference vectors and displacements provide directional and quantitative information on how the parameters of these elements are to be tuned to reduce the mismatch.

Performing the rendering and matching as detailed allows the refinement stage to attempt refinement of only the camera and geometry parameter classes. Without the additional information extracted from the apparent motion such an attempt would be likely to fail. By excluding surface coloring, textures, and lighting from the refinement, the dimensionality of the search space is sharply reduced.

Once refinement of the camera and geometry parameters has converged, each visible bit of geometry is rendered to the proper 2D pixel coordinates. The color of the corresponding pixels in the recorded camera frames should therefore be a result of the surface color of that bit of geometry together with the lighting, and any shadows, reflections, or other optical effects. The hue and to a lesser extent the saturation color components of the recorded pixel are likely to result mostly from the surface color. By rendering texture coordinates or vertex identifiers, it becomes possible to reverse map the recorded pixel colors into the appropriate texture or vertex color parameters of the model. Given a recorded pixel, this works by retrieving the corresponding rendered texture coordinates or vertex identifier plus any other required identifiers at the pixel's raster position and using these to locate the storage for the related color item in the model. The recorded pixel color can then be copied into that storage thereby setting an approximate value for that model color.

When the model represents the geometry by means other than vertices, reverse mapping proceeds as described under [0029] with the distinction that instead of vertex identifiers, alternate surface identifiers that lead back to where the surface colors are stored are to be used.

Reverse mapping can be made more precise by performing it for multiple frames and averaging the colors that map to the same parameter: surface colors are constant whereas lighting, shadows, and reflections tend to vary with time and viewpoint.

Video compression requires that rendering the model will accurately reproduce the recorded camera frames. Without precise modeling of color and lighting, this would appear to be impossible. However, reverse mapping [0029] can also be used to store the residual differences between the rendered and recorded frames with the model as texture maps for each frame. These texture map sequences can be compressed using conventional video compression methods. The resulting compression ratio should improve with the duration of the scene. During playback, there is limited freedom in choosing the viewpoint so that stereoscopic 3D displays can be supported.

What is claimed is:

1. A method of matching for an RMR based 3D scene model refinement system comprising:
per-frame rendering of a motion vector field given the scene model;
global and local matching of the rendered motion vector field to the corresponding motion vector field extracted from the video stream via a (standard or customized) motion estimation algorithm, thereby enabling directed adjustment of model parameters;
a hierarchical sequencing of model parameter class refinement when applying said method; and
the application of reverse mapping to attain approximate values for unrefined model parameter classes.
